(19) United States
(12) Patent Application Publication
(10) Pub. No.: US 2024/0279468 A1
(43) Pub. Date: Aug. 22, 2024

(54) CURABLE SILICONE RUBBER COMPOSITIONS

(71) Applicant: DOW SILICONES CORPORATION, Midland, MI (US)

(72) Inventors: Yusheng CHEN, Shanghai (CN); Fengyi SU, Shanghai (CN); Rui WANG, Shanghai (CN); Peng WANG, Shanghai (CN); Yi GUO, Shanghai (CN); Chun Ming ZHANG, Zhangjiagang, Jiangsu (CN)

(21) Appl. No.: 18/568,765

(22) PCT Filed: Jun. 11, 2021
(86) PCT No.: PCT/CN2021/099606

§ 371 Date: Dec. 8, 2023

(51) Int. Cl. C08L 83/04; C09J 183/04; C09K 3/10

(52) U.S. Cl. CPC C08L 83/04; C09J 183/04; C09K 3/1018

(57) ABSTRACT

This disclosure relates to curable silicone rubber compositions suitable for use in the manufacture of cured-in-place gaskets (CIPGs), silicone elastomers resulting from the cure of such compositions and methods for making CIPGs from such compositions. The inclusion of a compound having at least two trialkoxysilyl groups, at least two dialkoxyalkylsilyl groups or a mixture of two or more trialkoxysilyl groups, and dialkoxyalkylsilyl groups per molecule selected from: (i) (R¹⁰)_{z} (R¹¹)_{3-z} Si—(W)—Si (R¹¹)_{3-z} (R¹⁰)_{z}; or (ii) 1,3,5-tris[3-((R¹⁰)_{z}(R¹¹)_{3-z} Si)-D]-1,3,5-triazine-2,4,6(1H,3H,5H)-trione where each R¹¹ is independently an alkoxy group having 1 to 6 carbons; each R¹⁰ is independently R¹¹ or an alkyl group having 1 to 6 carbons, z is 0 or 1; W is a linear or branched alkylene having 1 to 12 carbons; and D is an alkylene group having from 1 to 6 carbons; provides CIPGs which show both a good adhesion to aluminium and a good compression set.

### CROSS-REFERENCE TO RELATED APPLICATIONS

This application is the U.S. National Stage of and claims priority to PCT/CN2021/099606 filed on 11 Jun. 2021, the content of which is incorporated herein by reference.

### TECHNICAL FIELD

This disclosure relates to curable silicone rubber compositions suitable for use in the manufacture of cured-in-place gaskets (CIPGs), silicone elastomers resulting from the cure of said compositions and methods for making cured-in-place gaskets from said curable silicone rubber compositions.

### BACKGROUND

Curable silicone rubber compositions, often referred to as hydrosilylation or addition curable liquid silicone rubber compositions comprising polydiorganosiloxane polymers having an average of 2 or more unsaturated groups selected from alkenyl and/or alkynyl groups, organohydrogensiloxanes containing silicon bonded hydrogen (Si—H) groups and platinum group containing catalysts are well known and are used for a wide variety of applications. However, such compositions are also well known for their reluctance to adhere to substrates against/on which the composition is cured. Many additives have been developed in attempting to obtain good adhesion of such compositions to substrates. However, when many of these additives are used to obtain adhesion, the compression set of the resulting elastomer (i.e. the permanent deformation remaining after removal of a force that was applied to it for a certain period of time at a certain temperature) significantly increases which for applications requiring low compression set is obviously a problem. For example, cured-in-place gaskets are a preferred means of sealing a wide variety of automotive and industrial applications. The silicone rubber composition is usually applied, in the case of a cured-in-place gasket, as a bead or thread of a silicone rubber composition from a suitable applicator onto a target surface which effectively creates a mold for the desired gasket. The applicators used may be pre-programmed robot applicators so that the introduction of the thread of silicone rubber composition may be controlled to provide a gasket having a desired shape and minimising waste. Once, the silicone rubber composition has been completely introduced it is cured in place. The silicone rubber compositions in the preparation of cured in place gaskets (CIPG) materials are usually stored as 2-part composition to prevent premature cure but when the two parts are mixed together it is critical that the reactive mixture applied in liquid form remains in the liquid state for a time sufficiently long to prevent contamination and/or blocking of the applicator. Furthermore, subsequent to cure the resulting CIPG must form an unprimed bond to the substrate on to which it is applied whilst also having good heat stability, low compression set and optionally low durometer (e.g. 30˜40 Shore A) product properties.

Cured in place gaskets (CIPGs) are used in a wide variety of automotive and industrial sealing applications and can be required to adhere to a wide variety of metal substrates such as aluminium (one of the major substrates in electric vehicle (EV) motor control unit (MCU) devices), coated metal substrates and/or plastic substrates. CIPGs may be utilised, for the sake of example to seal engine parts such as valve covers, rocker covers, timing chain covers, oil pans and the like in automotive engines and e.g. housing seals, and coolant area seals in the aforementioned motor control unit (MCU) devices for electric vehicle (EV)s as well as for an assortment of other industrial sealing applications.

A low compression set is required because the gasket is provided to prevent leaks at the joint formed between different parts. Low compression set is deemed to be a compression set of up to 40% after testing at 177° C. for 22 hours in accordance with ASTM D395 Method B is a maximum acceptable result. The ability to identify a CIPG with both good adhesion to aluminium substrates and a low compression set as defined above has been a long-term problem for the industry given existing CIPG silicone rubber compositions can demonstrate one or the other but not both. Low compression set, non-slump, fast cure, silicone rubber compositions are known but their adhesion with Aluminum substrates is not stable, especially for in low shore A (e.g. 30˜40) CIPG products. Whilst using adhesion promoter packages e.g. Zirconium(IV) acetylacetonate/γ-Glycidoxypropyltrimethoxysilane, Aluminum acetylacetonate and its solvent-toluene, tetra n-butyl titanate, glycidyloxypropyltrimethoxysilane, methyl methacrylate and/or tetrapropyl orthosilicate for unprimed adhesion to various metal and plastic substrates, stable adhesion with aluminum substrates can be achieved but the use of such adhesion promoters causes unacceptably high values for compression set of in the region of greater than or equal to 48% after testing at 177° C. for 22 hours in accordance with ASTM D395 Method B. In view of the foregoing, there remains an opportunity to provide curable and silicone compositions which upon cure and provide cured-in-place gaskets which provide low compression set of no more than 40%, alternatively no more than 39% after testing at 177° C. for 22 hours in accordance with ASTM D395 Method B and good adhesion with Aluminum substrates.

### SUMMARY

There is provided herein a curable silicone rubber composition comprising the following components:
a) a polydiorganosiloxane having at least two unsaturated groups per molecule, which unsaturated groups are selected from alkenyl or alkynyl groups;
b) an organosilicon compound having at least two, alternatively at least three Si—H groups per molecule;
c) at least one silica reinforcing filler or one or more non-reinforcing filler(s) selected from quartz, diatomaceous earth and calcium carbonate, or a mixture of both, each filler present being hydrophobically treated;
d) a hydrosilylation catalyst comprising or consisting of a platinum group metal or a compound thereof;
e) a tetraalkyltitanate wherein each alkyl group may be the same or different and has from 1 to 20 carbon atoms which is present in an amount of from 0.01 to 0.15 wt. % of the composition;
f) an alkylpolysilicate where the alkyl groups may be the same or different and may comprise up to 6 carbons per group, present in an amount of from 0 to 2.5 wt. % of the composition;
g) a suitable (meth)acrylate compound present in an amount of from 0.1 to 2.5 wt. % of the composition; and
h) a compound having at least two trialkoxysilyl groups, at least two dialkoxyalkylsilyl groups or a mixture of two or more trialkoxysilyl groups, and dialkoxyalkylsilyl groups per molecule selected from:

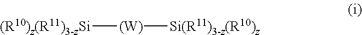

where each R¹¹ is the same or different and is an alkoxy group having 1 to 6 carbons; each R¹⁰ is the same or different and is R¹¹ or an alkyl group having 1 to 6 carbons, z is 0 or 1 and W is a linear or branched alkylene having 1 to 12 carbons; or

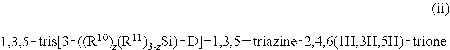

wherein R¹¹, R¹⁰ and z are as defined above and D is an alkylene group having from 1 to 6 carbons.

There is also provided herein a cured silicone rubber which is the product of curing the above curable silicone rubber composition.

There is also provided a cured silicone rubber obtained or obtainable by mixing and curing the curable silicone rubber composition described above and/or a cured-in-place gasket (CIPG) obtained or obtainable by mixing and curing the curable silicone rubber composition described above. There is also provided a cured silicone rubber or a cured-in-place gasket (CIPG) comprising the cured product of the curable silicone rubber composition described above.

There is provided a method for making a cured silicone rubber and/or a cured-in-place gasket (CIPG) by mixing and curing a curable silicone rubber composition comprising the following components
a) a polydiorganosiloxane having at least two unsaturated groups per molecule, which unsaturated groups are selected from alkenyl or alkynyl groups;
b) an organosilicon compound having at least two, alternatively at least three Si—H groups per molecule;
c) at least one silica reinforcing filler or one or more non-reinforcing filler(s) selected from quartz, diatomaceous earth and calcium carbonate, or a mixture of both, each filler present being hydrophobically treated;
d) a hydrosilylation catalyst comprising or consisting of a platinum group metal or a compound thereof;
e) a tetraalkyltitanate wherein each alkyl group may be the same or different and has from 1 to 20 carbon atoms which is present in an amount of from 0.01 to 0.15 wt. % of the composition;
f) an alkylpolysilicate where the alkyl groups may be the same or different and may comprise up to 6 carbons per group, present in an amount of from 0 to 2.5 wt. % of the composition;
g) a suitable (meth)acrylate compound present in an amount of from 0.1 to 2.5 wt. % of the composition; and h) a compound having at least two trialkoxysilyl groups, at least two dialkoxyalkylsilyl groups or a mixture of two or more trialkoxysilyl groups, and dialkoxyalkylsilyl groups per molecule selected from:

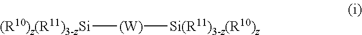

where each R¹¹ is the same or different and is an alkoxy group having 1 to 6 carbons; each R¹⁰ is the same or different and is R¹¹ or an alkyl group having 1 to 6 carbons, z is 0 or 1 and W is a linear or branched alkylene having 1 to 12 carbons; or

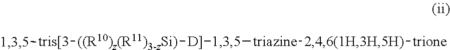

wherein R¹¹, R¹⁰ and z are as defined above and D is an alkylene group having from 1 to 6 carbons.

There is also provided a use of a curable silicone rubber composition to make a cured silicone rubber and/or a cured-in-place gasket (CIPG) which adheres to an aluminium substrate whilst retaining a compression set of less than or equal to 40%, alternatively less than or equal to 39% after testing at 177° C. for 22 hours in accordance with ASTM D395 Method B.

It has been surprisingly found that introducing component (h) in the above composition surprisingly improves the adhesion of the composition to aluminium substrates. Adhesion to said substrates has previously been a long-term problem i.e. the ability to enable good/stable adhesion of the CIPG to aluminium substrates (i.e. a lap shear of greater than (>) 1.5 MPa measured according to ASTM D 816 -82 (Reapproved 2001) using Type I lap specimen from FIG. 1 thereof) whilst retaining a compression set of less than or equal to 40%, alternatively 39% after testing at 177° C. for 22 hours in accordance with ASTM D395 Method B. Normally the addition of an adhesion promoter leads to good/stable adhesion but causes a significant increase in compression set to a value significantly greater than 40% after testing e.g. 48% or more at 177° C. for 22 hours in accordance with ASTM D395 Method B.

### DESCRIPTION OF EMBODIMENTS

All viscosity measurements referred to herein were measured at 25° C. unless otherwise indicated. “Hydrocarbyl” means a monovalent hydrocarbon group which may be substituted or unsubstituted. Specific examples of hydrocarbyl groups include alkyl groups, alkenyl groups, alkynyl groups, aryl groups, aralkyl groups, etc.

“Alkyl” means an acyclic, branched or unbranched, saturated monovalent hydrocarbon group. “Aryl” means a cyclic, fully unsaturated, hydrocarbon group. “Aralkyl” means an alkyl group having a pendant and/or terminal aryl group or an aryl group having a pendant alkyl group.

“Alkenylene” means an acyclic, branched or unbranched, divalent hydrocarbon group having one or more carbon-carbon double bonds. “Alkylene” means an acyclic, branched or unbranched, saturated divalent hydrocarbon group. “Alkynylene” means an acyclic, branched or unbranched, divalent hydrocarbon group having one or more carbon-carbon triple bonds. “Arylene” means a cyclic, fully unsaturated, divalent hydrocarbon group.

The term “substituted” as used in relation to another group, e.g. a hydrocarbyl group, means, unless indicated otherwise, one or more hydrogen atoms in the hydrocarbyl group has been replaced with another substituent. Examples of such substituents include, for example, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl.

M, D, T and Q units are generally represented as RᵤSiO(_{4-u)/2}, where u is 3, 2, 1, and 0 for M, D, T, and Q, respectively, and R is an independently selected hydrocarbyl group. The M, D, T, Q designate one (Mono), two (Di), three (Tri), or four (Quad) oxygen atoms covalently bonded to a silicon atom that is linked into the rest of the molecular structure.

### Component (a)

Component (a) is a polydiorganosiloxane having at least two unsaturated groups per molecule, which unsaturated groups are selected from alkenyl or alkynyl groups. Alternatively, component (a) has at least three unsaturated groups per molecule.

The unsaturated groups of component (a) may be terminal, pendent, or in both locations in component (a). For example, the unsaturated group may be an alkenyl group and/or an alkynyl group. Alkenyl is exemplified by, but not limited to, vinyl, allyl, methallyl, propenyl, and hexenyl groups. Alkenyl groups may have 2 to 30, alternatively 2 to 24, alternatively 2 to 20, alternatively 2 to 12, alternatively 2 to 10, and alternatively 2 to 6 carbon atoms. Alkynyl may be exemplified by, but not limited to, ethynyl, propynyl, and butynyl groups. Alkynyl groups may have 2 to 30, alternatively 2 to 24, alternatively 2 to 20, alternatively 2 to 12, alternatively 2 to 10, and alternatively 2 to 6 carbon atoms. Component (a) has multiple units of the formula (I):

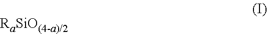

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to the alkenyl groups and alkynyl groups described above. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups (excluding fluoro containing groups) such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. The subscript “a” is 0, 1, 2 or 3.

Siloxy units may be described by a shorthand (abbreviated) nomenclature, namely - “M,” “D,” “T,” and “Q”, as discussed above (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R₁SiO_{3/2}; the Q unit corresponds to a siloxy unit where a=0, namely SiO_{4/2}. The polydiorganosiloxane of component (a) is substantially linear but may contain a proportion of however, there can be some branching due to the presence of T units (as previously described) within the molecule, hence the average value of a in structure (I) is about 2. Examples of typical R groups on component (a) include mainly alkenyl, alkynyl, alkyl, and/or aryl groups, alternatively alkenyl, alkyl, and/or aryl groups. The groups may be in pendent position (on a D or T siloxy unit) or may be terminal (on an M siloxy unit).

The silicon-bonded organic groups attached to component (a), other than the at least two unsaturated groups per molecule, selected from alkenyl or alkynyl groups, are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with the groups that do not interfere with curing of this inventive composition, such as halogen atoms. Preferred species of the silicon-bonded organic groups are, for example, alkyl groups such as methyl, ethyl, and propyl; and aryl groups such as phenyl.

Component (a) may be selected from polydimethylsiloxanes, alkylmethylpolysiloxanes, alkylarylpolysiloxanes or copolymers thereof (where reference to alkyl means an alkyl group having two or more carbons) containing e.g. alkenyl and/or alkynyl groups and may have any suitable terminal groups, for example, they may be trialkyl terminated, alkenyldialkyl terminated alkynyldialkyl terminated or may be terminated with any other suitable terminal group combination providing each polymer contains at least two unsaturated groups selected from alkenyl and alkynyl groups per molecule. In one embodiment the terminal groups of such a polymer has no silanol terminal groups.

Hence component (a) may, for the sake of example, be: a dialkylalkenyl terminated polydimethylsiloxane, e.g. dimethylvinyl terminated polydimethylsiloxane; a dialkylalkenyl terminated dimethylmethylphenylsiloxane, e.g. dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

In these embodiments, at a temperature of 25° C., the generally substantially linear organopolysiloxane of component (a) is typically a flowable liquid. Generally, the substantially linear organopolysiloxane has a viscosity of from 100 to 1,000,000 mPa·s, alternatively from 100 to 100,000 mPa·s, at 25° C. Viscosity may be measured at 25° C. using either a Brookfield® rotational viscometer with spindle LV-4 (designed for viscosities in the range between 1,000-2,000,000mPa·s) or a Brookfield® rotational viscometer with spindle LV-1 (designed for viscosities in the range between 15 -20,000mPa.s) for viscosities less than 1000mPa·s and adapting the shear rate according to the polymer viscosity.

### Component (b)

Component (b) is an organosilicon compound having at least two, alternatively at least three Si—H groups per molecule. The organosilicon compound (b) operates as a cross-linker for curing component (a), by the addition reaction of the silicon-bonded hydrogen atoms with the unsaturated groups in component (a) catalysed by component (d) described below. Component (b) normally contains three or more silicon-bonded hydrogen atoms so that the hydrogen atoms of this component can sufficiently react with the unsaturated groups of component (a) to form a network structure therewith and thereby cure the composition. Some or all of Component (b) may alternatively have two silicon bonded hydrogen atoms per molecule when component (a) has greater than (>) 2 unsaturated groups, alternatively alkenyl groups per molecule.

Component (b) may be a siloxane e.g. an organohydrogensiloxane or a silane e.g. a monosilane, disilane, trisilane, or polysilane providing each molecule has at least two, alternatively at least three Si—H groups per molecule. In acyclic polysilanes and polysiloxanes, the silicon-bonded hydrogen atoms can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms.

When component (b) is a siloxane it may comprise an organohydrogensiloxane, which can be a disiloxane, trisiloxane, or polysiloxane. The organohydrogensiloxane, may comprise any combination of M, D, T and/or Q siloxy units, so long as component (b) includes at least two silicon-bonded hydrogen atoms. These siloxy units can be combined in various manners to form cyclic, linear, branched and/or resinous (three-dimensional networked) structures. Component (b) may be monomeric, polymeric, oligomeric, linear, branched, cyclic, and/or resinous depending on the selection of M, D, T, and/or Q units.

Examples of component (b) include but are not limited to:
(i) trimethylsiloxy-terminated methylhydrogenpolysiloxane,
(ii) trimethylsiloxy-terminated polydimethylsiloxane-methylhydrogensiloxane,
(iii) dimethylhydrogensiloxy-terminated dimethylsiloxane-methylhydrogensiloxane copolymers,
(iv) dimethylsiloxane-methylhydrogensiloxane cyclic copolymers,
(v) copolymers composed of (CH₃)₂HSiO_{1/2} units and SiO_{4/2} units,
(vi) copolymers composed of (CH₃)₃SiO_{1/2} units, (CH₃)₂HSiO_{1/2} units, and SiO_{4/2} units; and
(vii) copolymers containing (CH₃)₂HSiO_{1/2} units and (R²Z)_{d}(R³)ₑ SiO_{(4-d-e)/2} as described above.

While the viscosity of this component is not specifically restricted, it may typically be from 0.001 to 50 Pa·s at 25° C. relying using either a Brookfield® rotational viscometer with spindle LV-4 (designed for viscosities in the range between 1,000-2,000,000mPa·s) or a Brookfield® rotational viscometer with spindle LV-1 (designed for viscosities in the range between 15 -20,000mPa·s) for viscosities less than 1000 mPa·s and adapting the shear rate according to the polymer viscosity.

Component (b) is typically added in an amount such that the molar ratio of the silicon-bonded hydrogen atoms in component (b) to that of all unsaturated groups in the composition is from 0.5:1 to 20:1; alternatively of from 0.5:1 to 5:1, alternatively from 0.6:1 to 3:1. When this ratio is less than 0.5:1, a well-cured composition will not be obtained. When the ratio exceeds 20:1, there is a tendency for the hardness of the cured composition to increase when heated. The amounts of each group mentioned in the above ratio, e.g. silicon-bonded hydrogen (Si-H) content of organohydrogenpolysiloxane (b) may be determined using quantitative infra-red analysis in accordance with ASTM E168, if desired. Typically, component (b) is present in the composition in an amount of from 0.5 to10 wt. % of the total composition which amount is determined dependent on the required molar ratio of the total number of the silicon-bonded hydrogen atoms in component (b) to the total number of all alkenyl and alkynyl groups in component (a).

### Component (c)

Component (c) is at least one silica reinforcing filler or one or more non-reinforcing filler(s) selected from quartz, diatomaceous earth and calcium carbonate, or a mixture of both, Alternatively, component (c) is one or more finely divided, silica reinforcing fillers and one or more non-reinforcing filler(s) selected from quartz, diatomaceous earth and calcium carbonate, alternatively, component (c) is one or more finely divided, silica reinforcing fillers and quartz. In the case of each alternative above, the respective fillers present are hydrophobically treated.

When component (c) comprises one or more reinforcing fillers, the reinforcing fillers maybe exemplified by finely divided fumed silica, colloidal silicas and/or a finely divided precipitated silica. Precipitated silica, fumed silica and/or colloidal silicas are particularly preferred because of their relatively high surface area, which is typically at least 50 m²/g (BET method in accordance with ISO 9277: 2010); alternatively, having surface areas of from 50 to 450 m²/g (BET method in accordance with ISO 9277: 2010), alternatively having surface areas of from 50 to 300 m²/g (BET method in accordance with ISO 9277: 2010), are typically used. All these types of silica are commercially available.

The silica reinforcing filler(s) of component (c) are naturally hydrophilic and are treated with a treating agent to render them hydrophobic. These surface modified reinforcing fillers of component (c) do not clump and can be homogeneously incorporated into polydiorganosiloxane polymer (a), described below, as the surface treatment makes the fillers easily wetted by polydiorganosiloxane polymer (a).

The silica reinforcing filler(s) may be surface treated with any suitable low molecular weight organosilicon compounds disclosed in the art applicable to prevent creping of LSR compositions during processing. For example, organosilanes, polydiorganosiloxanes, or organosilazanes e.g. hexaalkyl disilazane and short chain siloxane diols. Specific examples include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlrotrimethyl silane, dichlrodimethyl silane, trichloromethyl silane.

In one embodiment, the treating agent may be selected from silanol terminated vinyl methyl (ViMe) siloxane, liquid hydroxyldimethyl-terminated polydiorganosiloxane containing an average from 2 to 20 repeating units of diorganosiloxane in each molecule, hexaorganodisiloxanes, such as hexamethyldisiloxane, divinyltetramethyldisiloxane; hexaorganodisilazanes, such as hexamethyldisilazane (HMDZ), divinyltetramethyldisilazane and; hydroxyldimethyl terminated polydimethylmethylvinyl siloxane, octamethyl cyclotetrasiloxane, and silanes including but not limited to methyltriethoxysilane, dimethyldiethoxysilane and/or vinyltriethoxysilane. A small amount of water can be added together with the silica treating agent(s) as processing aid.

The surface treatment of untreated reinforcing fillers of component (c) may be undertaken prior to introduction in the composition or in situ (i.e. in the presence of at least a portion of the other ingredients of the composition herein by blending these ingredients together at room temperature or above until the filler is completely treated. Typically, untreated reinforcing filler (c) is treated in situ with a treating agent in the presence of polydiorganosiloxane polymer (a) which results in the preparation of a silicone rubber base material which can subsequently be mixed with other ingredients.

As previously indicated component (c) may also alternatively or additionally contain one or more non-reinforcing filler(s) selected from quartz, diatomaceous earth and calcium carbonate. Each non-reinforcing filler when present is also hydrophobically treated with the treating agents as described above with respect to the reinforcing fillers.

Component (c) is optionally present in an amount of up to 40 wt. % of the composition, alternatively from 1.0 to 40wt. % of the composition, alternatively of from 5.0 to 35wt. % of the composition, alternatively of from 10.0 to 35wt. % of the composition.

### Component (d)

Component (d) of the curable silicone rubber composition is a platinum group metal based hydrosilylation cure catalyst. These are usually selected from catalysts of the platinum group metals (platinum, ruthenium, osmium, rhodium, iridium and palladium), or a compound of one or more of such metals. For example, the catalyst (d) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal contained in the catalyst is platinum or rhodium due to the high activity level of these catalysts in hydrosilylation reactions, with platinum most preferred. In a hydrosilylation (or addition) reaction a hydrosilylation catalyst such as component (d) herein catalyses the reaction between an unsaturated group, usually an alkenyl group e.g. vinyl with Si—H groups.

Examples of preferred hydrosilylation catalysts (d) are platinum based catalysts, for example, platinum black, platinum oxide (Adams catalyst), platinum on various solid supports, chloroplatinic acids, e.g. hexachloroplatinic acid (Pt oxidation state IV) (Speier catalyst), chloroplatinic acid in solutions of alcohols e.g. isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g. tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution—. Platinum catalysts with phosphorus, sulfur, and amine ligands can be used as well, e.g. (Ph₃P)₂PtCl₂; and complexes of platinum with vinylsiloxanes, such as sym-divinyltetramethyldisiloxane.

Hence, specific examples of suitable platinum-based catalysts include
(i) complexes of chloroplatinic acid with organosiloxanes containing ethylenically unsaturated hydrocarbon groups are described in U.S. Pat. No. 3,419,593;
(d) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives, but the use of vinyl siloxane polymers is by far the preferred choice.

These are described in U.S. Pat. Nos. 3,715,334 and 3,814,730. In one preferred embodiment component (d) may be selected from co-ordination compounds of platinum. In one embodiment hexachloroplatinic acid and its conversion products with vinyl-containing siloxanes, Karstedt's catalysts and Speier catalysts are preferred.

The catalyst may be added as a single species or as a mixture of two or more different species. Typically, dependent on the form/concentration in which the catalyst is provided the amount of platinum group metal present, alternatively the amount of platinum metal present will be within the range of from 0.1-1.5 wt. % of the composition, alternatively from 0.1-1.0 wt. %, alternatively 0.1 to 0.5 wt. %, of the composition. Components (e) and (g) are essential whilst component (f) is optional.

### Component (e)

Component (e) is a tetraalkyltitanate. Each alkyl group of the tetraalkyltitanate (e) may be the same or different but is usually the same and are selected from alkyl radicals having up to 20 carbon atoms. Useful tetraalkyltitanates include tetraisopropyltitanate, tetrabutyltitanate and tetraoctyltitanate. Component (e) the tetraalkyltitanate is typically used in an amount of from 0.01 to 0.15 wt. % of the composition, alternatively 0.01 to 0.1 wt. % of the composition, alternatively 0.02 to 0.075 wt. % of the composition.

### Component (f)

Optionally the composition may comprise component (f) an alkylpolysilicate. The alkylpolysilicate may be partially hydrolyzed tetraalkyl silicate where the alkyl groups may be the same or different and may comprise up to 6 carbons per group, alternatively up to four carbons per group atoms. Examples of component (f), when present may include but are not limited to ethylpolysilicate and butylpolysilicate. The alkylpolysilicate (f) may be present in an amount of up to 2.5 wt. % of the composition, alternatively in an amount of from 0 (zero) to 2.0 wt. % of the composition. When present alkylpolysilicate (f) may be present in an amount of from 0.5 to 2 wt. % of the composition.

### Component (g)

There is also provided component (g) a suitable (meth)acrylate compound such as alkyl, alkenyl and aryl esters of acrylic or methacrylic acid, i.e. acrylates or methacrylates referred to herein as (meth)acrylates. Each alkyl group, when present comprises from 1 to 10 carbons per alkyl group, alternatively from 1 to 6 carbons per alkyl group, specific examples may include but are not limited to methyl, ethyl, butyl and octyl; each alkenyl group typically contain from 2 to 10 carbon atoms, alternatively from 2 to 6 carbons per alkenyl group and may include, for the sake of example, vinyl, allyl and/or butenyl groups; the aryl groups typically contain from 6 to 10 carbon atoms in the esters. The aryl groups may be phenyl or naphthyl. The (meth)acrylate compound may be selected from, but is not limited to alkyl (meth)acrylates such as methyl (meth)acrylate, ethyl (meth)acrylate, butyl (meth)acrylate, ureido (meth)acrylate, 2-ethylhexyl (meth)acrylate, 2-propylheptyl (meth)acrylate and decyl (meth)acrylate; alkenyl (meth)acrylates include vinyl (meth)acrylate, allyl (meth)acrylate and butenyl (meth)acrylate. Aryl (meth)acrylates include phenyl (meth)acrylate, naphthyl (meth)acrylate and tolyl (meth)acrylate. Aralkyl (meth)acrylates include phenylethyl (meth)acrylate. Cycloalkyl (meth)acrylate include cyclohexyl (meth)acrylate. Preferably the (meth)acrylate compound is an alkyl (meth)acrylate. The (meth)acrylate compound is typically present in an amount of from 0.1 to 2.5 wt. % of the composition, alternatively in an amount of from 0.1 to 2.0 wt. % of the composition, alternatively 0.5 to 2.0 wt. %.

### Component (h)

Component (h) of the curable silicone rubber composition is a compound having at least two trialkoxysilyl groups, at least two dialkoxyalkylsilyl groups or a mixture of two or more trialkoxysilyl groups, and dialkoxyalkylsilyl groups per molecule selected from:

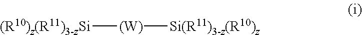

where each R¹¹ is the same or different and is an alkoxy group having 1 to 6 carbons; each R¹⁰ is the same or different and is R¹¹ or an alkyl group having 1 to 6 carbons, z is 0 or 1 and W is a linear or branched alkylene group having 1 to 12 carbons; or

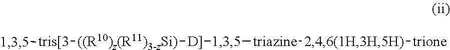

wherein R¹¹, R¹⁰ and z are as defined above and D is an alkylene group having from 1 to 6 carbons.

In one alternative, component (h) of the curable silicone rubber composition may be a compound having at least two trialkoxysilyl groups, at least two dialkoxyalkylsilyl groups or a mixture of two or more trialkoxysilyl groups, and dialkoxyalkylsilyl groups per molecule of the formula

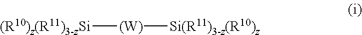

where each R¹¹ is the same or different and is an alkoxy group having 1 to 6 carbons, alternatively 1 to 4 carbons, alternatively is selected from methoxy, ethoxy or propoxy, alternatively is methoxy; each R¹⁰ is the same or different and is R¹¹ or an alkyl group having 1 to 6 carbons, alternatively R¹¹ or an alkyl group having 1 to 4 carbons, alternatively R¹¹ or methyl, ethyl or propyl groups; Subscript z is 0 or 1 but preferably subscript z is zero. W is a linear or branched alkylene having 1 to 12 carbons, alternatively a linear or branched alkylene having 1 to 6 carbons, alternatively a linear or branched alkylene having 1 to 4 carbons, alternatively W is linear. Hence, in one embodiment when z is zero, component (h)(i) has the formula

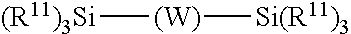

Furthermore, in an alternative embodiment when each R¹¹ is a methoxy group or an ethoxy group (h)(i) has the formula

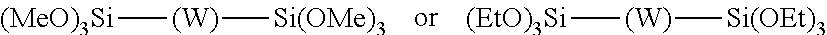

where Me is a methyl and Et is an ethyl. In which case component (h)(i) may be, for example bis(trimethoxysilyl)ethane, bis(trimethoxysilyl)propane, bis(trimethoxysilyl)butane bis(trimethoxysilyl)pentane, bis(trimethoxysilyl)hexane or bis(triethoxysilyl)ethane, bis(triethoxysilyl)propane, bis(triethoxysilyl)butane, bis(triethoxysilyl)pentane or Bis(triethoxysilyl)hexane respectively.

Alternatively, Component (h) of the curable silicone rubber composition may be a compound at least two trialkoxysilyl groups, at least two dialkoxyalkylsilyl groups or a mixture of two or more trialkoxysilyl groups, and dialkoxyalkylsilyl groups per molecule of the formula

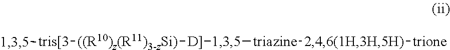

where each R¹¹ is the same or different and is an alkoxy group having 1 to 6 carbons, alternatively 1 to 4 carbons, alternatively is selected from methoxy, ethoxy or propoxy, alternatively is methoxy; each R¹⁰ is the same or different and is R¹¹ or an alkyl group having 1 to 6 carbons, alternatively R¹¹ or an alkyl group having 1 to 4 carbons, alternatively R¹¹ or methyl, ethyl or propyl groups; Subscript z is 0 or 1 but preferably subscript z is zero. D is a linear or branched alkylene having 1 to 12 carbons, alternatively a linear or branched alkylene having 1 to 6 carbons, alternatively a linear or branched alkylene having 1 to 4 carbons, alternatively D is linear. Hence, in one embodiment when z is zero, component (h)(ii) has the formula

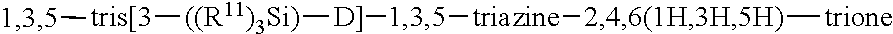

Furthermore, in an alternative embodiment when each R¹¹ is a methoxy group (h)(ii) has the formula

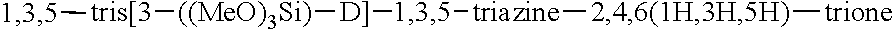

The content of the component (h) in the composition is from about 0.2 to about 5 wt. % of the composition; alternatively, from 0.2 to 2.5 wt. % of the composition, alternatively from 0.2 to 1.5 wt. % of the composition. The critical aspect is that the introduction of component (h) enables the cured silicone rubber to adhere to aluminium substrates without a significant increase in compression set.

### Optional Additive(s)

The composition may optionally further comprise additional ingredients hereafter referred to as “optional additives” which provide a benefit to the composition or subsequently cured material and do not prevent the curable silicone rubber compositions from curing.

Examples of optional additives include, but are not limited to, cure inhibitors; surfactants; colorants, including dyes and pigments; anti-oxidants; carrier vehicles; heat stabilizers; flame retardants; metal deactivators; flow control additives; lubricating oils, oil bleeding agents, adhesion promoters, stabilizers, such as heat stabilizers, conductive stability improvers, foam stabilizers and/or UV stabilizers; dispersants, slip agents, toughening agents, anti-oxidants and thixotropic agents.

One or more of the additives can be present as any suitable weight percent (wt. %) of the composition, such as about 0.1 wt. % to about 15 wt. %, about 0.5 wt. % to about 5 wt. %, or about 0.1 wt. % or less, about 1 wt. %, 2, 3, 4, 5, 6, 7, 8, 9, 10, 11, 12, 13, 14, or about 15 wt. % or more of the composition. In the case of pigments and/or colorants the amount present may be as great as 20 wt. % of the composition if deemed necessary. One of skill in the art can readily determine a suitable amount of additive depending, for example, on the type of additive and the desired outcome. Certain optional additives are described in greater detail below.

The composition as described herein may further comprise a hydrosilylation reaction inhibitor to inhibit the cure of the composition. Hydrosilylation reaction inhibitors are used, when required, to prevent or delay the hydrosilylation reaction curing process especially during storage. The optional hydrosilylation reaction inhibitors of platinum based catalysts are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, such as 3-methyl-3-penten-1-yne, 3,5-dimethyl-3-hexen-1-yne hydroperoxides, nitriles, and diaziridines. Alkenyl-substituted siloxanes as described in US3989667 may be used, of which cyclic methylvinylsiloxanes such as 1,3,5,7-tetramethyl-1,3,5,7-tetravinylcyclotetrasiloxane, 1,3,5,7-tetramethyl-1,3,5,7-tetrahexenylcyclotetrasiloxane, are preferred.

One class of known hydrosilylation reaction inhibitor includes the acetylenic compounds disclosed in U.S. Pat. No. 3445420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C.or above to cure at a practical rate. Examples of acetylenic alcohols and their derivatives include 3-methyl-1-butyn-3-ol, 1-ethynyl-1-cyclohexanol (ETCH), 2-methyl-3-butyn-2-ol, 3-butyn-1-ol, 3-butyn-2-ol, propargyl alcohol, 1-phenyl-2-propyn-1-ol, 3,5-dimethyl-1-hexyn-3-ol, 3-phenyl-1-butyn-3-ol, 1-ethynylcyclopentanol, 3-methyl-1-penten-4-yn-3-ol, and mixtures thereof. Derivatives of acetylenic alcohol may include those compounds having at least one silicon atom.

When present, inhibitor concentrations as low as 1 mole of inhibitor per mole of the metal of catalyst will in some instances impart satisfactory storage stability and cure rate. In other instances, inhibitor concentrations of up to 500 moles of inhibitor per mole of the metal of catalyst are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10 wt. % of the composition.

The composition as described herein may further comprise one or more pigments and/or colorants which may be added if desired. The pigments and/or colorants may be coloured, white, black, metal effect, and luminescent e.g. fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, ß-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants when present are present in the range of from 2, alternatively from 3, alternatively from 5 wt. % of the composition to 20, alternatively to 15 wt. % of the composition, alternatively to 10 wt. % of the composition.

Another optional additive herein are metal deactivators i.e. fuel additives and oil additives used to stabilize fluids by deactivating (usually by sequestering) metal ions, mostly introduced by the action of naturally occurring acids in the fuel and acids generated in lubricants by oxidative processes with the metallic parts of the systems e.g. dodecanedioic acid, bis[2-(2-hydroxybenzoyl)hydrazide].

The composition may also comprise one or more oil resistance agents such as magnesium hydroxide (Mg(OH)₂).

The curable silicone rubber compositions as described herein are usually stored in two parts to avoid premature cure. The two parts are generally referred to as part A and part B. Two-part compositions are prepared so that components (b) cross-linker, and (d) catalyst are not stored together in the same part to avoid premature cure. For example, Part A may comprise components (a) polymer, (c) filler (s) and (d) catalyst and Part B comprises at least components (a) polymer and (b) cross-linker and usually (c) filler, with part A free of component (b) cross-linker and part B free of component (d) catalyst. Typically Component (e) may be present in part A, and components f), g) and h) are added to the part B composition.

Preferably when present, the cure inhibitor is in part A with component (d). The other optional components of the composition can be in either or both part A and part B or if desired may be introduced in one or more additional parts separate from the two parts (such that the system may be a three- or more part system). The two-part composition may be designed to be mixed together in any suitable ratio dependent on the content and concentration of the ingredients present in each part, for example the two-part composition may be mixed in a Part A : Part B weight ratio of from 5:1 to 1:5.

Any suitable process may be utilised to prepare cured-in-place gaskets (CIPGs) with the composition described herein, for example the process may for example comprise the following steps:
(i) mixing a part A composition and a part B composition in a predefined weight ratio;
(ii) transporting the mixture prepared in step (i) to a suitable applicator;
(iii) dispensing the resulting mixture from the applicator onto a substrate surface; and
(iv) enabling the mixture to cure and provide a silicone cured-in-place gasket.

Before step (i) of the above process the ingredients of the part A composition are blended together and separately the ingredients of the part B composition are also blended together to form respective part A and part B compositions.

Typically, the part A and part B compositions are stored for a period of time before use. In step (i) the part A composition and part B compositions are mixed to form a curable mixture of the silicone rubber composition described above. Any suitable mixer may be used, for example the mixer may be a static mixer or a stirred tank or the like suitable for undertaking thorough mixing of the respective blend compositions. Optionally the mixing container is temperature controllable such that the part A composition and part B compositions being mixed can be maintained within a desired temperature range. In step (ii) the composition produced in step (i) is transported to a suitable applicator. This may be by a pump. Given the composition is being used to prepare cured-in-place gaskets (CIPGs), preferably the applicator is a pre-programmed or programable robot applicator which can be used to apply the composition to the target substrate surface which may be planar but more likely is provided with a groove into which the composition is intended to be received. The composition should be applied in an amount that provides a satisfactorily performing gasket whilst minimising waste. Typically, the applicator will be programed to apply an optimized amount of composition at a pre-determined dispensing flow rate such that the gaskets are formed as and where required and then allowed to cure in place. As the composition herein is hydrosilylation/addition cured the cure step is usually undertaken at an elevated temperature and as such in the case of a continuous process, target substrates may be placed in pre-defined positions on a conveyor belt which transports each substrate to a position designed for application of the composition using a robotic applicator. The applicator applies composition in a pre-programed pattern and then the substrate is transported on the conveyor belt through a heating zone of a conveyor oven at a desired temperature e.g. at a temperature of 120° C. to 180ºC, alternatively 130° ° C.to 160° ° C. alternatively 145° C. to 160° C. for a desired period of time e.g. several minutes, such as for the sake of example 2 to 20 minutes, alternatively 5 to 20 minutes, alternatively 5 to 15 minutes. If desired the substrate may be conveyed through a pre-heating oven prior to application of the composition to make the CIPG.

Compositions described herein cure at elevated temperatures. After curing, the gasket may optionally be subjected to a post-curing step. Post-curing can be utilised to stabilize the performance of cured gasket in a short time e.g. 30 minutes to 3 hours, e.g. 1 hour.

After cure, and optionally post-cure, appropriate softness properties, compression set, and in some cases high gasket height to width ratios are required. Property adjustment in the uncured and cured state is a function of reactants, relative stoichiometry of reactants.

The balance of properties will vary in response to the specific requirements of a given application for form-in-place gaskets. Custom formulating becomes an essential task for satisfying the many applications for gasket formulations described herein.

In the case of the present disclosure it is preferred that the substrate onto which a bead of curable silicone rubber compositions as described herein is applied to form an uncured CIPG, prior to cure, is at least partially made from aluminium, alternatively, is an aluminium substrate. This will allow for the unexpected benefit identified when using the composition herein for making CIPGs to take effect, namely enhanced adhesion to aluminium whilst maintaining a low compression set of less than or equal to 40%, alternatively less than or equal to 39%, after testing at 177° C. for 22 hours in accordance with ASTM D395 Method B.

For optimum performance CIPGs preferably require a balance of properties. Uncured CIPG compositions such as the compositions herein are liquid with a low enough viscosity for easy dispensing via the applicator (and the avoidance of blockages in the applicator), whilst being non-slumping, after dispensing, to maintain the shape and dimensions of the intended gasket until cured in place. Hence, when first formed, each blend/composition of part A, part B and the resulting combination thereof can have a wide viscosity range dependent on the ingredients used. In various embodiments, the composition has a viscosity of from 1,000 to 100,000 mPa·s, alternatively from 1,000 to 50,000 mPa·s, alternatively from 1,000 to 25,000 mPa·s, alternatively from1,000 to 10,000 mPa·s, alternatively from 1,000 to about 7,500 mPa·s, and alternatively from 2,500 to 5,000 mPa·s. The viscosity may be determined using any suitable method understood in the art, for example, using a Brookfield® rotational viscometer with spindle LV-4 (designed for viscosities in the range between 1,000-2,000,000mPa·s) or a Brookfield® rotational viscometer with spindle LV-1 (designed for viscosities in the range between 15 -20,000mPa·s) for viscosities less than 1000mPa·s and adapting the shear rate according to the polymer viscosity.

The CIPGs, compositions, and methods herein are useful to for applications such as acting as a barrier to prevent absorption or penetration of air, dust, noise, liquids, gaseous substances, or dirt. The gaskets are ideal for sound dampening, vibration dampening, shock-absorbing elements moisture protection, chemical protection, and air sealing. Examples of suitable automotive applications include automotive gasket applications e.g. gaskets for electric vehicle (EV) battery packs, EV battery, control units in EVs, e.g. housing seals, and coolant area seals in motor control unit (MCU) devices, lamp housings, fuse boxes, air filters, oil pan gaskets, oil seal case gaskets, oil screen gaskets, timing belt cover upper gaskets, timing rocker cover lower gaskets; gaskets for electrical appliances such as waterproof connectors, air conditioners, lighting devices, electronic components, housings, preferably control cabinets, lamps, drums (packaging) or filter housings, attached by foaming to a substrate in situ as described herein. Other applications include external waterproofing applications.

The following examples, illustrating the compositions, CIPGs, and methods, are intended to illustrate and not to limit the disclosure herein.

### EXAMPLES

Compositions were generated utilizing different types and amounts of components. These are detailed below. All amounts are in wt. % unless indicated otherwise. As discussed above all viscosities are measured at 25° C. The viscosity of individual ingredients may be determined by any suitable method such as using a Brookfield® rotational viscometer with spindle LV-4 (designed for viscosities in the range between 1,000-2,000,000mPa·s) or a Brookfield® rotational viscometer with spindle LV-1 (designed for viscosities in the range between 15 -20,000mPa·s) for viscosities less than 1000mPa·s and adapting the shear rate according to the polymer viscosity. The alkenyl and/or alkynyl content of polymers as well as the silicon-bonded hydrogen (Si-H) content and/or silanol content of ingredients was determined using quantitative infra-red analysis in accordance with ASTM E168.

In the following examples and comparative examples two different masterbatches (MB) were prepared with a view to in-situ treating the fillers (fumed silica and quartz) and the compositions thereof are indicated in Table 1 below

TABLE 1
Master batches 1 & 2 used in the Examples and Comparatives (approx. weight % (wt. %))

| | MB 1 | MB 2 |
|---|---|---|
| Vinyldimethyl-terminated polydimethyl siloxane polymer-viscosity | 60.25 | 60.35 |
| of about 65,000 mPa · s (polymer 1) | | |
| Vinyldimethyl-terminated polydimethyl, methylvinyl, siloxane | | 5.5 |
| polymer-viscosity of about 300 mPa · s and vinyl of 1.15% wt | | |
| Fumed silica-BET surface ave. of about 400 m²/g | 15.5 | 26.5 |
| Untreated quartz-D50 ave. particle size of 4.5 μm | 15.5 | |
| Hexamethyldisilazane (HMDZ) | 5 | 5.5 |
| Divinyl teteramethyldisilazane | 1 | 0.05 |
| Dimethylhydroxy terminated polydimethylsiloxane viscosity of about | 1 | |
| 35 mPa · s | | |
| Methylvinyl diol | | 0.35 |
| Water | 1.75 | 1.75 |

The BET values were measured in accordance with ISO 9277.
Methylvinyl diol is a Dimethylhydroxy terminated polydimethylmethylvinylsiloxane having a viscosity of about 30 mPa · s at 25° C. and a vinyl content of about 12.0 wt. %;

A mixture of examples and comparative examples were prepared. Given all examples are hydrosilylation cured compositions, the compositions were prepared in two parts. As described above the part A compositions contain the catalyst and the part B compositions contain the cross-linker. The part A compositions for examples 1 to 10 are depicted in Table 2a, in which it will be seen that the part A compositions of Ex. 1 to 8 are the same.

TABLE 2
part A compositions for Examples Ex. 1 to 8 (same for all) and for Ex. 9 and
Ex. 10 in (wt. %)

| | Ex. 1-8 | Ex. 9 | Ex. 10 | Ex. 11 |
|---|---|---|---|---|
| MB 1 | 95.985 | 98.384 | 98.3966 | |
| MB 2 | | | | 93.00 |
| polymer 1 | 0.9154 | 0.9154 | 0.9154 | 3.9004 |
| Aluminium acetylacetonate | 0.0006 | 0.0006 | | 0.0006 |
| Toluene | 0.012 | 0.012 | | 0.012 |
| Tetra n-Butyl titanate | 0.038 | 0.038 | 0.038 | 0.038 |
| Treated Mg(OH)₂ | 2.399 | | | 2.399 |
| Karstedt catalyst solution | 0.65 | 0.65 | 0.65 | 0.65 |

The aluminium acetonate is delivered in solution in toluene.
The part B compositions for examples 1 to 5 are depicted in Table 2b and those for examples 6 to 10 are depicted in Table 2c.

TABLE 2b
Part B compositions for Examples Ex. 1 to 5 (wt. %)

| | Ex. 1 | Ex. 2 | Ex. 3 | Ex. 4 | Ex. 5 |
|---|---|---|---|---|---|
| MB 1 | 94.761 | 94.561 | 94.761 | 93.961 | 94.961 |
| SiH crosslinker | 1.32 | 1.32 | 1.32 | 1.32 | 1.32 |
| Comp. (h) 1 | 1.00 | 1.00 | 0.50 | 2.00 | |
| Comp. (h) 2 | | | 0.50 | | 1.00 |
| Adhesion Promoter 1 | 0.204 | 0.204 | 0.204 | 0.204 | 0.204 |
| Methyl methacrylate | 1.417 | 1.417 | 1.417 | 1.217 | 1.217 |
| Tetrapropyl orthosilicate | 1.217 | 1.217 | 1.217 | 1.217 | 1.217 |
| Metal deactivator | | 0.20 | | | |
| Inhibitor (ETCH) | 0.081 | 0.081 | 0.081 | 0.081 | 0.081 |

In the above table, SiH crosslinker is an Si—H dimethyl terminated resinous Si—H polysiloxane having a viscosity of 25 mPa · s at 25° C. and a silicon bonded hydrogen content of about 9,600 ppm; Component (h) 1 (Comp. (h) 1) is Bis(trimethoxysilyl)hexane

Component (h) 2 (Comp. (h) 2) is 1,3,5-tris[3-(trimethoxysilyl)propyl]-1,3,5-triazine-2,4,6(1H,3H,5H)-trione; and

Adhesion Promoter 1 was Glycidoxypropyltrimethoxysilane.

TABLE 2c
Part B compositions for Examples Ex. 6 to 10 (wt. %)

| | Ex. 6 | Ex. 7 | Ex. 8 | Ex. 9 | Ex. 10 | Ex. 11 |
|---|---|---|---|---|---|---|
| MB 1 | 93.961 | 94.961 | 94.961 | 96.178 | 96.178 | |
| MB2 | | | | | | 93.00 |
| Polymer 1 | | | | | | 1.781 |
| SiH crosslinker | 1.32 | 1.32 | 1.32 | 1.32 | 1.32 | 1.50 |
| Comp. (h) 1 | | 1.204 | | 1.00 | 1.00 | 1.00 |
| Comp. (h) 2 | 2.00 | | | | | |
| Comp. (h) 3 | | | 1.00 | | | |
| Adhesion | 0.204 | | 0.204 | 0.204 | 0.204 | 0.204 |
| Promoter 1 | | | | | | |
| Methyl | 1.217 | 1.217 | 1.217 | 1.217 | 1.217 | 1.217 |
| methacrylate | | | | | | |
| Tetrapropyl | 1.217 | 1.2170 | 1.2170 | | | 1.2170 |
| orthosilicate | | | | | | |
| Inhibitor | 0.081 | 0.0810 | 0.0810 | 0.0810 | 0.0810 | 0.0810 |
| (ETCH) | | | | | | |

In the above Comp. (h) 3 is Bis(trimethoxysilyl)ethane. For laboratory testing, the Part A and Part B compositions for each example and comparative example were independently homogeneously mixed and then the respective part A′s and part B′s were combined in a 1:1 weight ratio. The combined mixture was also homogeneously mixed for 12 seconds and de-aired using a speed mixer. The walls of the mixer were then scraped down and the mixture was mixed again for a further 12 seconds. Samples of the resulting compositions were tested with respect to slump/flow was measured (mm) according to ASTM D2202. A slump jig was filled with the mixture resulting from the 2 x 12 seconds cycles mixing Part A with Part B. Any excess was removed and the fixture was moved to the vertical. Readings of the slump/flow of the composition were taken after 10 minutes and are provided in the physical property Tables 3a and 3b below.

The resulting de-aired mixtures were introduced into mold cavities and cured to prepare suitable test sheets of 2.0 mm thickness by press curing at 150° C. for 5 minutes in order to prepare samples for Hardness (Shore A), and Tensile strength and elongation at break testing. In the case of preparing test pieces for compression set testing, 12.0-13.0 mm thickness specimens(small discs) were press cured at 150° C. for a period of 10 minutes. Irrespective of the test undertaken, all test specimens were stored at room temperature for 16-24 hours before physical property testing.

Physical property testing of the different examples was then undertaken using the following methodologies:

### Shore A Hardness

Shore A hardness was measured following test ASTM D2240-97.

### Tensile Strength and Elongation at Break

The tensile strength and elongation at break results were obtained via ASTM D412-98A.

### Compression Set (%)

Compression set results were obtained in accordance with ASTM D395 Method B after 177° C. for 22Hrs.

### Lap Shear Adhesion

Lap shear adhesion (MPa) for Aluminium/aluminium (AL/AL) and Polyamide (nylon) 66/ polyamide 66 (PA66/PA66) were both measured according to ASTM D 816-82 (Reapproved 2001) using Type I lap specimen from FIG. 1 thereof. The aluminium panels during the lap shear testing were ALCLAD 2024T3 panels from Q-Lab Corporation and were 2.54 cm wide. The PA 66 panels during the examples were PA66 GF30 type from Shanghai Qiyao Chemical Co. Ltd and likewise were 2.54 cm wide. Each aluminium and polyamide 66 substrate panels was first cleaned using isopropyl alcohol (IPA) solvent and then left to dry for at least 30 minutes at room temperature. Testing was undertaken by firstly applying the respective uncured composition between top and bottom panels giving a 1cm overlap. The resulting test pieces were then allowed to sit at room temperature for 10 minutes and were then cured for 15 minutes at 150° C. in the oven and finally cooled for 24 hours prior to testing. The results for Ex. 1- 5 are depicted in Table 3a and those for Ex. 6 to 10 are depicted in table 3b.

TABLE 3a
Physical Property testing for Ex. 1 to 5

| Performance testing: | Ex. 1 | Ex. 2 | Ex. 3 | Ex. 4 | Ex. 5 |
|---|---|---|---|---|---|
| Flow (mm) | 0.2 | 0.2 | 0.2 | 0.2 | 0.2 |
| Compression set (177º C./ | 27.8 | 24.0 | 33.0 | 24.3 | 28.0 |
| 22 Hrs) (%) | | | | | |
| Lap shear (AL/AL) (MPa) | 2.47 | 2.57 | 2.51 | 2.8 | 3.0 |
| Lap shear (PA66/PA66) | 2.7 | 2.24 | 2.17 | 2.4 | 3.0 |
| (MPa) | | | | | |
| Hardness, (Shore A) | 33.5 | 30 | 30 | 34 | 33 |
| Tensile strength, (MPa) | 7.92 | 6.78 | 7.48 | 7.85 | 7.65 |
| Elongation at break (%) | 721 | 751 | 762 | 731 | 720 |

TABLE 3b
Physical Property testing for Ex. 6 to 10

| Performance testing: | Ex. 6 | Ex. 7 | Ex. 8 | Ex. 9 | Ex. 10 | Ex. 11 |
|---|---|---|---|---|---|---|
| Flow (mm) | 0.2 | 0.2 | 0.2 | 0.2 | 0.2 | 0.2 |
| Compression set (177° C./22 Hrs) (%) | 33.2 | 26.9 | 26.7 | 27.2 | 26.9 | 38.5 |
| Lap shear (AL/AL) (MPa) | 3.22 | 3.21 | 2.43 | 2.31 | 2.78 | 2.36 |
| Lap shear (PA66/PA66) (MPa) | 2.99 | 1.90 | 3.06 | 2.40 | 2.50 | 1.96 |
| Hardness, (Shore A) | 32 | 32 | 35 | 37 | 37 | 32 |
| Tensile strength, (MPa) | 6.94 | 7.44 | 7.46 | 7.76 | 8.07 | 8.45 |
| Elongation at break (%) | 680 | 639 | 670 | 620 | 702 | 838 |

It can be seen that all examples 1 to 11 had compression set values of less than 40, indeed all but Ex. 11 had compression set values of less than 35. However, it is to be particularly noted that not only do they have such excellent compression set values they also have excellent lap shear results of greater than 2.25 MPa with respect to the difficult substrate aluminium. In Ex. 11 it can be seen that whilst both compression set and lap shear results were acceptable the absence of quartz is seemingly detrimental to performance but even in its absence the compression set was still under 40% when comp. (h) 1 is present. Although both compression set and lap shear results were acceptable the absence of Quartz lead to a poorer result. This indicates that the addition of component (h) in addition to standard adhesion promoters provides excellent compression set without the known issue that by increasing the presence of adhesion promoters to enhance the level of adhesion to aluminium compression set is compromised. It can also be seen that the compositions used are effectively non-slump and all maintain excellent physical properties subsequent to cure.

A series of comparative examples (C. 1 to C. 6) were also undertaken using the exact same methodologies. The compositions utilised are depicted in Table 4a (part A compositions) and table 4b (part B compositions).

TABLE 4a
Part A compositions for Comparatives C. 1 to C. 6

| | C. 1 | C. 2 | C. 3 | C. 4 | C. 5 | C. 6 |
|---|---|---|---|---|---|---|
| MB 1 | 95.985 | | 95.985 | 91.301 | 91.301 | 95.985 |
| MB 2 | | 62.5994 | | | | |
| Untreated quartz | | 15.00 | | | | |
| polymer 1 | 0.9154 | 19.3010 | 0.9154 | 4.60 | 4.60 | 0.9154 |
| Aluminium | 0.0006 | 0.0006 | 0.0006 | | | 0.0006 |
| acetylacetonate | | | | | | |
| Toluene | 0.012 | 0.0120 | 0.012 | | | 0.012 |
| Tetra n-Butyl titanate | 0.038 | 0.0380 | 0.038 | | | 0.038 |
| Zirconium (IV) AcAc | | | | 1.60 | 1.60 | |
| Treated Mg(OH)₂ | 2.399 | 2.399 | 2.399 | 2.399 | 2.399 | 2.399 |
| Karstedt catalyst | 0.6500 | 0.6500 | 0.650 | 0.10 | 0.10 | 0.65 |
| solution | | | | | | |

In the above zirconium (IV) AcAc is a masterbatch of 50% by weight of zirconium(IV) acetylacetonate in vinyldimethyl-terminated polydimethyl siloxane polymer with viscosity of about 450 mPa · s

TABLE 4b
Part B compositions for Comparatives C. 1 to C. 6

| | C. 1 | C. 2 | C. 3 | C. 4 | C. 5 | C. 6 |
|---|---|---|---|---|---|---|
| MB 1 | 95.961 | | 94.961 | 93.511 | 93.311 | 94.961 |
| MB 2 | | 62.60 | | | | |
| Untreated quartz | | 15.00 | | | | |
| polymer 1 | | 18.181 | | 3.688 | 3.688 | |
| SiH crosslinker | 1.32 | 1.50 | 1.32 | 1.32 | 1.32 | 1.32 |
| Methyl methacrylate | 1.217 | 1.217 | 1.217 | | | 1.217 |
| Tetrapropyl orthosilicate | 1.217 | 1.217 | 1.217 | | | 1.217 |
| Adhesion Promoter 1 | 0.204 | 0.204 | 0.204 | 1.400 | 1.400 | 0.204 |
| Adhesion Promoter 2 | | | 1.00 | | | |
| Adhesion Promoter 3 | | | | | | 1.00 |
| Metal deactivator | | | | | 0.20 | |
| Inhibitor (ETCH) | 0.081 | 0.081 | 0.081 | 0.081 | 0.081 | 0.081 |

In the above Table 4b:-
Adhesion Promoter 2 is a reaction product of glycidoxypropyltrimethoxysilane and dimethyl hydroxy-terminated Dimethyl, methylvinyl siloxane, and Adhesion Promoter 3 is Bis(trimethoxysilylpropyl)amine.

Analogous testing was undertaken using the same testing methods and the results for the comparatives are depicted in Table 5 below. However, results are only provided for C. 1 to C.5 as C. 6 did not cure.

TABLE 5
Physical Property testing for C. 1 to C. 5

| Performance testing: | C. 1 | C. 2 | C. 3 | C. 4 | C. 5 |
|---|---|---|---|---|---|
| Slump/Flow (mm) | 0.3 | 6.0 | 0.2 | 0.2 | 0.2 |
| Compression set (177° C./22 Hrs) (%) | 24.9 | 36.6 | 50.2 | 48 | 44.2 |
| Lap shear (AL/AL) (MPa) | 0.56 | 0.60 | 3.02 | 2.17 | 2.68 |
| Lap shear (PA66/PA66) (MPa) | 0.95 | 0.81 | 2.5 | 2.00 | 1.88 |
| Hardness, (Shore A) | 33 | 32 | 34 | 38 | 38 |
| Tensile strength, (MPa) | 7.97 | 6.61 | 7.4 | 7.63 | 7.67 |
| Elongation at break (%) | 715 | 592 | 685 | 674 | 610 |

It can be seen that for aluminium substrates whilst comparative example C. 1 provides excellent compression set the lap shear results between aluminium substrates is found wanting and is inadequate. In comparative example C. 2 it can be seen that an unwanted Slump/Flow (mm) result occurs but C. 2 also has a poor lap shear result for the aluminium substrates. It is believed (without being bound to current theories) that the poor slump/flow result is due to the fact that quartz non-reinforcing filler is present in the composition of C. 2 but that it was untreated. Hence, it would seem that when quartz is present in the composition that it does need to be hydrophobically treated. Comparatives 3 and 4 contain increased levels of standard adhesion promoters and consequently show improved adhesion in the aluminium lap shear testing. However, they give poor compression set results, unlike the compositions of Ex. 1 to 11 which all contain comp. (h) in the present compositions. It can also be seen that by replacing Comp. (h) with adhesion promoter 3 that the presence of the amine group in adhesion promoter 3 appears to be the cause of C. 6 not curing.

Hence, it can be seen that the comparative examples result in products with either good lap shear adhesion to aluminium or good compression set but not both and it was found herein that the use of comp (h) as described herein unexpectedly overcame this issue providing both good compression set, i.e. less than 40% whilst maintaining good adhesion to aluminium substrates as evidenced from the lap shear results. This means that the enclosed compositions are suitable for applications involving the need for the adhesion of aluminium substrates in conjunction with good compression set.

1. A curable silicone rubber composition comprising:
a) a polydiorganosiloxane having at least two unsaturated groups per molecule, which unsaturated groups are selected from alkenyl or alkynyl groups;
b) an organosilicon compound having at least two, optionally at least three Si—H groups per molecule;
c) at least one silica reinforcing filler or one or more non-reinforcing filler(s) selected from quartz, diatomaceous earth and calcium carbonate, or a mixture of both, each filler present being hydrophobically treated;
d) a hydrosilylation catalyst comprising or consisting of a platinum group metal or a compound thereof;
e) a tetraalkyltitanate wherein each alkyl group may be the same or different and has from 1 to 20 carbon atoms which is present in an amount of from 0.01 to 0.15 wt. % of the composition;
f) an alkylpolysilicate where the alkyl groups may be the same or different and may comprise up to 6 carbons per group, present in an amount of from 0 to 2.5 wt. % of the composition;
g) a suitable (meth)acrylate compound present in an amount of from 0.1 to 2.5 wt. % of the composition; and
h) a compound having at least two trialkoxysilyl groups, at least two dialkoxyalkylsilyl groups or a mixture of two or more trialkoxysilyl groups, and dialkoxyalkylsilyl groups per molecule selected from: 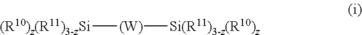
where each R¹¹ is the same or different and is an alkoxy group having 1 to 6 carbons;
each R¹⁰ is the same or different and is R¹¹ or an alkyl group having 1 to 6 carbons, z is 0 or 1 and W is a linear or branched alkylene having 1 to 12 carbons; or 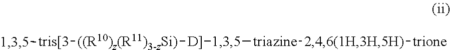
wherein R¹¹, R¹⁰ and z are as defined above and D is an alkylene group having from 1 to 6 carbons.

2. The curable silicone rubber composition in accordance with claim 1, wherein component (h) is selected from bis(trimethoxysilyl)ethane, bis(trimethoxysilyl)propane, bis(trimethoxysilyl)butane, bis(trimethoxysilyl)pentane, bis(trimethoxysilyl)hexane, bis(triethoxysilyl)ethane, bis(triethoxysilyl)propane, bis(triethoxysilyl)butane, bis(triethoxysilyl)pentane, bis(triethoxysilyl)hexane and/or is 1,3,5-tris[3-(trimethoxysilyl)propyl]-1,3,5-triazine-2,4,6(1H,3H,5H)-trione.

3. The curable silicone rubber composition in accordance with claim 1, wherein the composition additionally comprises one or more cure inhibitors, metal deactivators and/or oil resistance agents.

4. The curable silicone rubber composition in accordance with claim 3, wherein the metal deactivator is dodecanedioic acid, bis[2-(2-hydroxybenzoyl)hydrazide] and/or the oil resistance agent is magnesium hydroxide.

5. The curable silicone rubber composition in accordance with claim 1, wherein component c) comprises at least one silica reinforcing filler and quartz.

6. A cured silicone rubber which is the product of curing the curable silicone rubber composition in accordance with claim 1.

7. A cured in place gasket comprising or consisting of the cured product of the curable silicone rubber composition in accordance with claim 1.

8. The cured in place gasket in accordance with claim 7, adhered to an aluminium substrate.

9. A method for making a cured silicone rubber and/or a cured-in-place gasket (CIPG) by mixing and curing the a curable silicone rubber composition in accordance with claim 1.

10. The method for making a cured silicone rubber and/or a cured-in-place gasket (CIPG) in accordance with claim 9, wherein the silicone rubber composition is applied onto a substrate as a bead or thread of a silicone rubber composition from an applicator onto a target surface.

11. The method for making a cured silicone rubber and/or a cured-in-place gasket (CIPG) in accordance with claim 10, wherein the applicator is a pre-programmed robot applicators so that the introduction of the thread of silicone rubber composition is controlled to provide a gasket.

12. The method for making a cured silicone rubber and/or a cured-in-place gasket (CIPG) in accordance with claim 9, any one of claims 9, wherein the method is continuous such that target substrates are placed in pre-defined positions on a conveyor belt which transports each substrate to a position designed for application of the composition using a robotic applicator, the applicator applies composition in a pre-programed pattern and then the substrate is transported on the conveyor belt through a heating zone of a conveyor oven at a temperature of from 120° C. to 180° C. for a period of from 2 to 20 minutes.

13. A cured silicone rubber obtained or obtainable by mixing and curing a the curable silicone rubber composition and/or a cured-in-place gasket (CIPG) obtained or obtainable by mixing and curing a the curable silicone rubber composition on a suitable substrate, wherein the curable silicone rubber composition is in accordance with claim 1.

14. The cured silicone rubber and/or a cured-in-place gasket (CIPG) in accordance with claim 13, which adheres to an aluminium substrate such that with a lap shear of greater than (>) 1.5 MPa measured according to ASTM D 816-82 (Reapproved 2001) whilst retaining a compression set of less than or equal to 40% after testing at 177° C. for 22 hours in accordance with ASTM D395 Method B.

15. The cured silicone rubber and/or a cured-in-place gasket (CIPG) in accordance with claim 13, suitable for use as a barrier to prevent absorption or penetration of air, dust, noise, liquids, gaseous substances, or dirt; sound damping, vibration damping, shock-absorbing elements moisture protection, chemical protection, and air sealing and/or for automotive applications, air filters, oil pan gaskets, oil seal case gaskets, oil screen gaskets, timing belt cover upper gaskets, timing rocker cover lower gaskets; gaskets for electrical appliances, waterproof connectors, air conditioners, lighting devices, and electronic components.

16. Use of a curable silicone rubber composition-The cured silicone rubber and/or a cured-in-place gasket (CIPG) in accordance with claim 15, wherein the automotive applications comprise automotive gasket applications selected from gaskets for electric vehicle (EV) battery packs, gaskets for EV batteries, gaskets for motor control units in EVs, housing seals, and coolant area seals.
